(19) United States
(12) Patent Application Publication
(10) Pub. No.: US 2014/0251316 A1
(43) Pub. Date: Sep. 11, 2014

(54) Collapsible Grill

(71) Applicant: Alexander Unitas, Shelton, CT (US)

(72) Inventor: Alexander Unitas, Shelton, CT (US)

(21) Appl. No.: 14/196,076

(22) Filed: Mar. 4, 2014

Related U.S. Application Data
(60) Provisional application No. 61/774,072, filed on Mar. 7, 2013.

(51) Int. Cl. A47J 33/00

(52) U.S. Cl. CPC A47J 33/00
USPC 126/9 B

(57) ABSTRACT

Disclosed is a collapsible grill comprising a pair of vertical supports comprising a plurality of apertures with a plurality of grill bars. The vertical supports have three types of apertures; the apertures extending along one edge of the vertical supports are tapped, the complementary series of apertures extending along the opposing edge are smooth, pass-through apertures, and the apertures disposed therebetween are adapted to allow heat to disperse through the sides of the device. The grill bars extend through complimentary apertures on the complimentary vertical supports to form two parallel, substantially planar surfaces, a cooking surface and a surface for holding the fuel source. The grill bars are easily removable when cooking is completed, allowing the grill to collapse into a very compact size.

### CROSS REFERENCE TO RELATED APPLICATION

This application claims the benefit of U.S. Provisional Application No. 61/774,072 filed on Mar. 7, 2013, entitled “Moto-Grill.” The above identified patent application is herein incorporated by reference in its entirety to provide continuity of disclosure.

### BACKGROUND OF THE INVENTION

1. Field of the Invention

The present invention relates to campfire or outdoor grills or barbecues. Specifically, the invention relates to collapsible grills or grills that have removable grill bars.

For many people, one of the most enjoyable aspects of being outdoors or camping is grilling. Most camping grills are designed to be more lightweight and easier to transport than their conventional brethren, but many types are nonetheless cumbersome to take on long hikes or require a substantial amount of effort to assemble. Without a grill, it may take an individual a substantial amount of time and effort to build a fire and cook food.

Many different types of devices have been created in order to address the problems inherent in attempting to cook food outdoors. Canister stoves are small and provide the ability to quickly swap out pre-packaged fuel canisters with minimal effort by the user, but they also rely on expensive fuel and it is difficult to ascertain when that fuel is running low. Upright canister designs are extremely compact, but only offer a single burner for a single pot or pan and are prone to tipping over. Low-profile canister designs avoid the problems with tipping, but are also bulkier and heavier. Integrated stove canister systems whereby the canister is directly attached to a pot can be useful, but they are also less versatile since that pot is the only option and temperature control on them is difficult. Other types of stoves or grills attempt to address the problems of outdoor cooking devices by being collapsible, rather than just small. These grills generally involve some type collapsible support structure upon which the grill surface is placed or the legs of the grill fold up to a position flush with the grill surface. These grills are larger than the canister stove models and try to preserve the overall character of a grill, but are nonetheless challenging to transport substantial distances in the outdoors and may require an investment of time to assemble.

The present invention seeks to solve all of these issues with outdoor food preparation technologies. The bottom rack provided by the collapsible grill can house any type of fuel that the user wishes, rather than having an integrated fuel system that requires the user to utilize a specific type of fuel. The collapsible grill is also extremely small when fully collapsed. The collapsible grill consists of only two apertured plates and a set of bars. All the parts together can easily fit into a small bag. The collapsible grill is also extremely quick and easy to assemble. The only required assembly is that a set of light bars must be placed through two complimentary holes on the vertical supports, then the individual is free to begin heating the grill.

2. Description of the Prior Art

Devices have been disclosed in the prior art that relate to collapsible outdoor grills. These include devices that have been patented and published in patent application publications. These devices generally relate to grills that are collapsed by removing the cooking surface and then folding up the support structure or by folding the grill's legs back. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 2,058,836 to Silver, which discloses a collapsible grill comprised of legs, side bars, grate bars, and windshield plates. Silver is assembled by unfolding the legs, connecting the series of windshields between the legs, placing the sidebars over the legs and tightening the wing nuts that hold the side bars to the legs, then finally hooking the looped grate bars over T-shaped depressions on the side bars and tightening the open end of the grate bars to lock them into position. There are several key differences between Silver and the present invention. First, Silver requires substantially more assembly than the present invention, which only requires a set of metal bars to be inserted through holes. Second, Silver requires wing nuts and other tightening mechanisms to be utilized to keep the grill stable. Finally, Silver provides a mechanism for protecting against the wind from interfering with the fire, but it does not provide a mechanism for heat dissipation.

Another such device is U.S. Pat. No. 4,126,116 to McCallum, which discloses a portable barbecue device comprised of four collapsible panels secured at the corners by posts to form a frame and a grill section that unfolds and is placed over the frame. The McCallum device differs in several key design aspects. McCallum utilizes a four-wall system, whereas the present invention only has two walls. McCallum uses a foldable grill that is placed over the frame, which is secured by stakes, whereas the present invention uses grill bars that double as both the cooking surface and the method by which the grill is secured. To collapse the present invention, the grill bars are pulled from the support structure, but to collapse the McCallum device the preformed grill surface is lifted from the support structure, then the stakes are removed from the corners of the frame, and the frame is then finally folded up. These are two fundamentally different methods for designing a grill to collapse.

U.S. Pat. No. 4,920,950 to Johnson discloses a portable camp grill having a grill surface within a frame, a handle on the frame, and two legs that fold into a position where they are flush against the grill surface. Like the prior references, Johnson follows a similar concept in providing a grill intended for outdoor camping, but diverges in several key design decisions. The present invention does not utilize folding or collapsible legs to make the grill transportable. Rather the entire grill, including the grill surface and the surface adapted for holding the fuel source, can be taken apart to completely collapse the grill. In both Johnson and McCallum the actual grill surface cannot be disassembled, whereas in the present invention it can be.

The present invention is a new and improved collapsible grill. It differs from the prior art in the degree to which it can be collapsed and the ease of its assembly. The present invention is extremely easy to assemble and disassemble because all the user is required to do is to thread the grill bars through complimentary apertures. The collapsible grill is also extremely small once collapsed because the entire device consists only of two small plates and a plurality of grill bars. The present invention substantially diverges in design elements from the prior art and consequently it is clear that there is a need in the art for an improvement to existing collapsible camping or outdoor grill devices. In this regard the instant invention substantially fulfills these needs.

### SUMMARY OF THE INVENTION

In view of the foregoing disadvantages inherent in the known types of outdoor grills now present in the prior art, the present invention provides a new collapsible grill wherein the same can be utilized for providing convenience for the user when seeking to prepare food while camping, hiking, or in other outdoor scenarios where traditional grills are too bulky or cumbersome to transport.

It is therefore an object of the present invention to provide a new and improved collapsible grill device that has all of the advantages of the prior art and none of the disadvantages.

It is another object of the present invention to provide a collapsible grill that can be quickly and easily assembled and disassembled.

Another object of the present invention is to provide a collapsible grill that is compact in size and easy to store when collapsed.

Another object of the present invention is to provide a collapsible grill that is capable of heating up and cooking food in an outdoor environment.

Another object of the present invention is to provide a collapsible grill that can use a wide range of heat sources.

Yet another object of the present invention is to provide a grill that has a mechanism for heat dissipation to prevent food from burning too quickly.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the vertical support and grill bar components of the present invention.

FIG. 2A shows a perspective view of the present invention in its compact configuration.

FIG. 2B shows a perspective view of the present invention partially constructed.

FIG. 2C shows a perspective view of the present invention partially constructed.

FIG. 3 shows a perspective view of the present invention fully assembled.

FIG. 4 shows a perspective view of multiple grills of the present invention aligned together.

FIG. 5 shows a perspective view of an alternative embodiment of the present invention having scalloped edges.

### DETAILED DESCRIPTION OF THE INVENTION

Reference is made herein to the attached drawings. Like reference numerals are used throughout the drawings to depict like or similar elements of the collapsible grill. For the purposes of presenting a brief and clear description of the present invention, the preferred embodiment will be discussed as used for grilling or cooking food while camping, hiking, or doing another outdoor activity. The figures are intended for representative purposes only and should not be considered to be limiting in any respect.

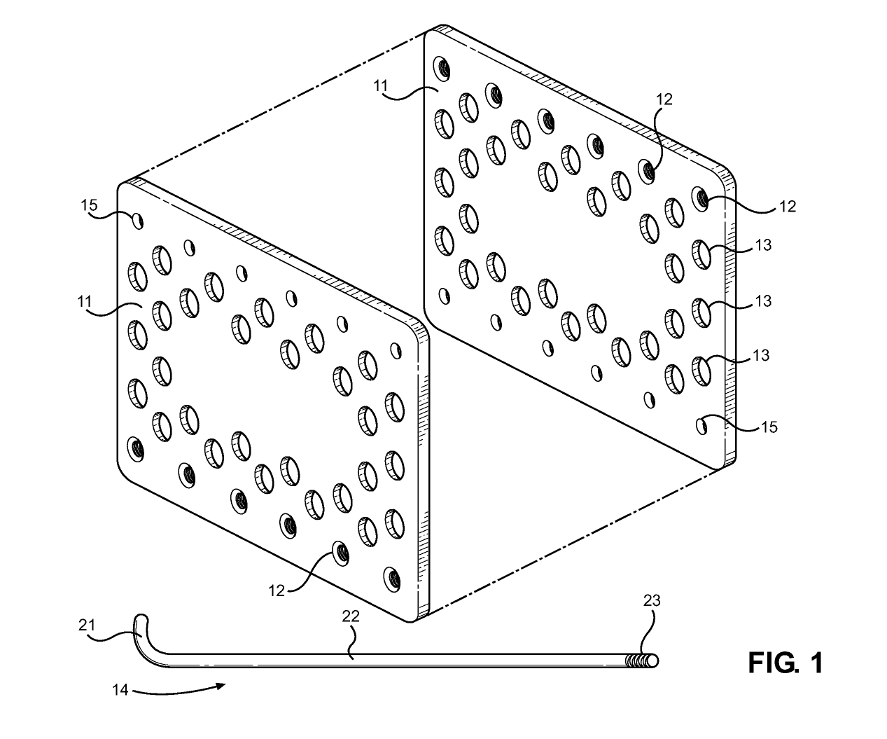

Referring now to FIG. 1, there is shown a perspective view of the vertical support and grill bar components of the present invention. The present invention comprises a pair of vertical supports 11 that are adapted to provide a firm base to support a plurality of grill bars 14 extending therebetween. The vertical supports 11 are depicted in a roughly rectangular configuration with smooth, flat edges, but no specific structure for the vertical supports 11 is contemplated, beyond what is described below. Each vertical support 11 has a plurality of tapped apertures 12 aligned in a row at one edge and a plurality of pass-through apertures 15 aligned in a row at the opposing edge. In the preferred embodiment of the present invention, the pair of vertical supports 11 each have an equal number of tapped apertures 12 and pass-through apertures 15. However, in an alternative embodiment, each vertical support 11 may have an unequal number of tapped apertures 12 and pass-through apertures 15. In this embodiment, the first vertical support has a number of tapped apertures 12 equal to the number of pass-through apertures on the second vertical support and a number of pass-through apertures 15 equal to the number of tapped apertures 12 on the opposing vertical support.

The grill bars 14 comprise a threaded end 23, an elongated portion 22, and a blocker 21. The tapped apertures 12 have internal threading adapted to engage with the threaded end 23 of the grill bars 14. The pass-through apertures 15 have a diameter allowing the threaded end 23 of the grill bars 14 to pass therethrough and allowing the elongated portion 22 to be slidably inserted therethrough, while still holding the grill bars 14 snugly in place when threaded through a pair of complimentary apertures 12, 15. The blocker 21 prevents the elongated portion 22 of the grill bars 14 from being pulled all the way through the pass-through apertures 15, thereby holding the grill bars 14 securely in place between the blocker 21 and the tapped apertures 15 on the opposing vertical support 11. As depicted, the blocker 21 comprises a curved end, but no claim is made as to the specific structure of the blocker 21. The blocker 21 may further comprise a plug, a portion of the grill bar having an enlarged diameter greater than the pass-through apertures 15, or any other structure preventing the grill bars 14 from being pulled therethrough.

The grill bars 14 are roughly cylindrical in shape in the depicted embodiment, but no size or shape of the bars is specifically claimed. The material of the grill bars 14 comprises cast iron, stainless steel, or any other type of metallic material that is capable of being heated to sufficient temperatures to cook food without melting. In an alternative embodiment of the present invention, the metal grill bars 14 may further be coated with a non-stick coating. The apertures 12, 15 are aligned in rows because the grill bars 14, when inserted through the pass-through apertures 15 and secured to the complimentary tapped aperture 12 on the opposing vertical support 11, form a pair of level, substantially planar surfaces. The top level surface acts as the cooking surface and the bottom level surface acts as the surface upon which the heat source lies. The heat source may be charcoal, wood, camping stoves that are small enough to fit in the space between the cooking surface and the heat source surface, or anything that generates a sufficient amount of heat to cook food. However, which planar surface may be used for which purpose may be freely interchanged because in the preferred embodiment the number of tapped 12 and pass-through apertures 15 on each of the vertical supports is equal 11, creating a collapsible grill that has two symmetrical surfaces.

A plurality of heat dispersion apertures 13 are dispersed throughout the area of the vertical support 11 between the top and bottom rows of apertures 12, 15. The heat dispersion apertures 13 are preferably included due to the device's compact design. Because of the small size of the collapsible grill, most heat sources raise the temperature of the cooking surface too quickly, resulting in the food being burned. The heat dispersion apertures 13 allow heat to dissipate through the sides of the device, causing the temperature of the cooking surface to rise gradually because less of the heat is directed upwards through the cooking surface, thereby preventing food from being burned. However, embodiments are contemplated both with and without heat dispersion apertures 13. For embodiments with heat dispersion apertures 13, they may be dispersed in any manner throughout the face of the vertical supports 11 and may vary in size and shape.

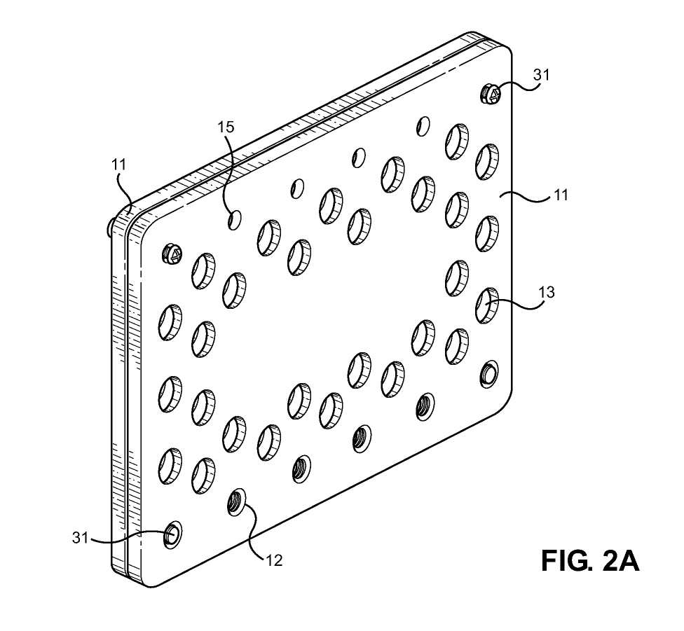

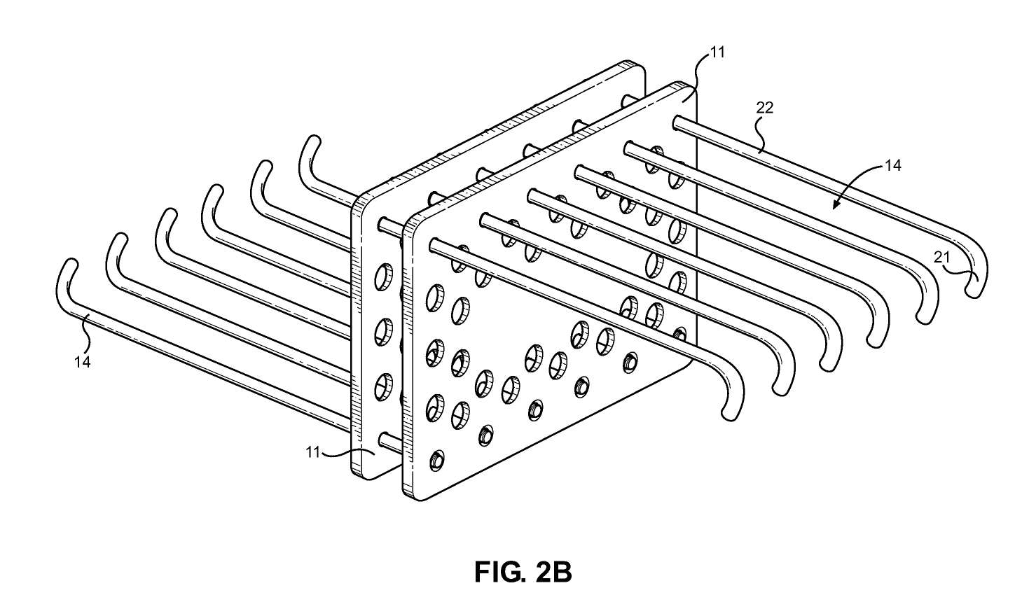

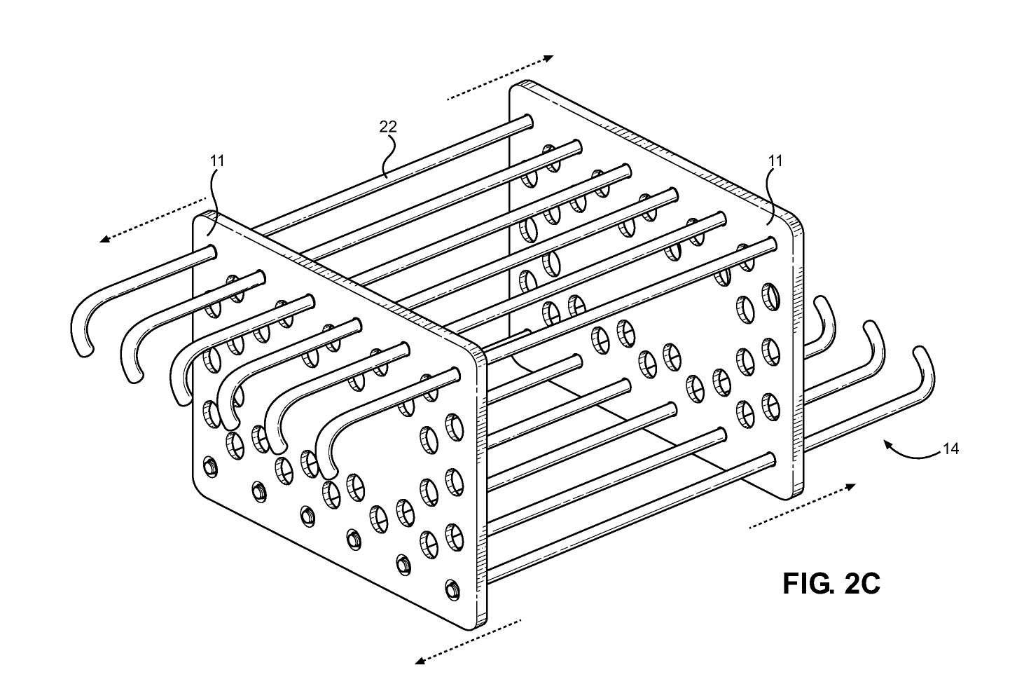

Referring now to FIGS. 2A, 2B, and 2C, there are shown perspective views of various stages of the construction of the present invention. The vertical supports 11 of the present invention may be removably affixed together by a set of fasteners 31 in a compact configuration suitable for storage. The fasteners 31 are secured in much the same manner as the grill bars; the fasteners 31 are placed through a pass-through aperture 15 and secured to the corresponding tapped aperture 12. The threaded portion of the fastener 31 engages with the tapped aperture 12, holding the fastener to the second vertical support 11 and causing the head of the fastener 31 to bear against the first vertical support, thereby holding the two vertical supports 11 flush against each other. In an alternative embodiment, the fasteners 31 may have a length and design such that a space is created between the pair of vertical supports 11, thereby allowing the grill bars to be placed therebetween with the blockers of the grill bars placed through the heat dispersion apertures 13, holding the vertical supports 11 ad the grill bars 14 together as a single, neat package.

The present collapsible grill is constructed by inserting the threaded end of each of the grill bars 14 through a pass-through aperture 15 on the first vertical support 11 and screwing the threaded end into the aligned complimentary tapped aperture 12 on the second vertical support 11. This process is repeated for each of the grill bars 14 and each of the complimentary apertures 12, 15 on the opposing vertical supports 11. The vertical supports 11 are then slid over the smooth, elongated portions 22 of the grill bars 14 until halted by the blockers 21. The blockers 21 hold one end of the grill bars 14 in place and the threaded end engaged with the tapped apertures 12 holds the other end of the grills bars 14 in place. The grill bars 14 are therefore securely held between the opposing vertical supports 11, creating a level, planar surface that is capable of supporting objects without having said objects roll or otherwise fall off of the present invention when in use. The grill bars 14 form a balanced framework when fully assembled that can adequately support the weight of pots or pans, food, and the heat source. No other securement means is necessary to keep the present collapsible grill intact when in use.

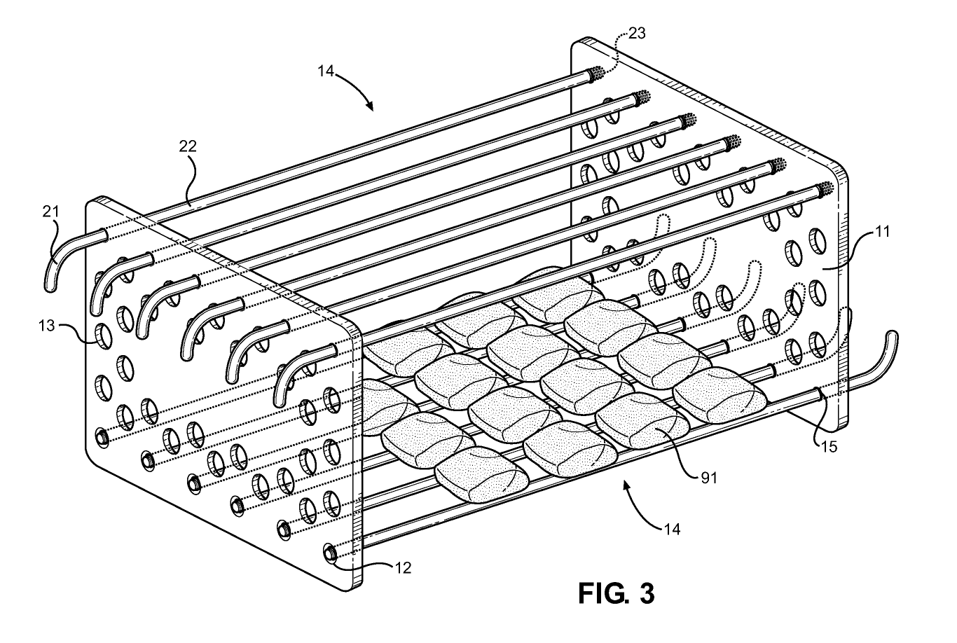

Referring now to FIG. 3, there is shown a perspective view of a fully constructed present collapsible grill. The vertical supports 11 are horizontally aligned so that the rows of tapped apertures 12 and pass-through apertures 15 on the opposing vertical supports 11 are substantially level. The plurality of grill bars 14 extending between the top rows of complimentary apertures 12, 15 forms the cooking surface. The cooking surface must be level or else food will fall off and will not be cooked. The plurality of grill bars extending between the bottom rows of complimentary apertures 12, 15 forms the surface that supports the heat source 91. This surface also must be level or else the heat source 91 will fall off.

The vertical supports 11 and the grill bars 14 may be composed of any substance that can withstand the heat generated by the heat source. In the depicted preferred embodiment the grill bars 14 are curved at one end to prevent them from slipping out of the pass-through apertures 15 in the vertical supports 11. The grill bars 14 are not permanently affixed within the apertures. The grill bars 14 are easily removable as the grill is designed to be collapsible for ease of transport.

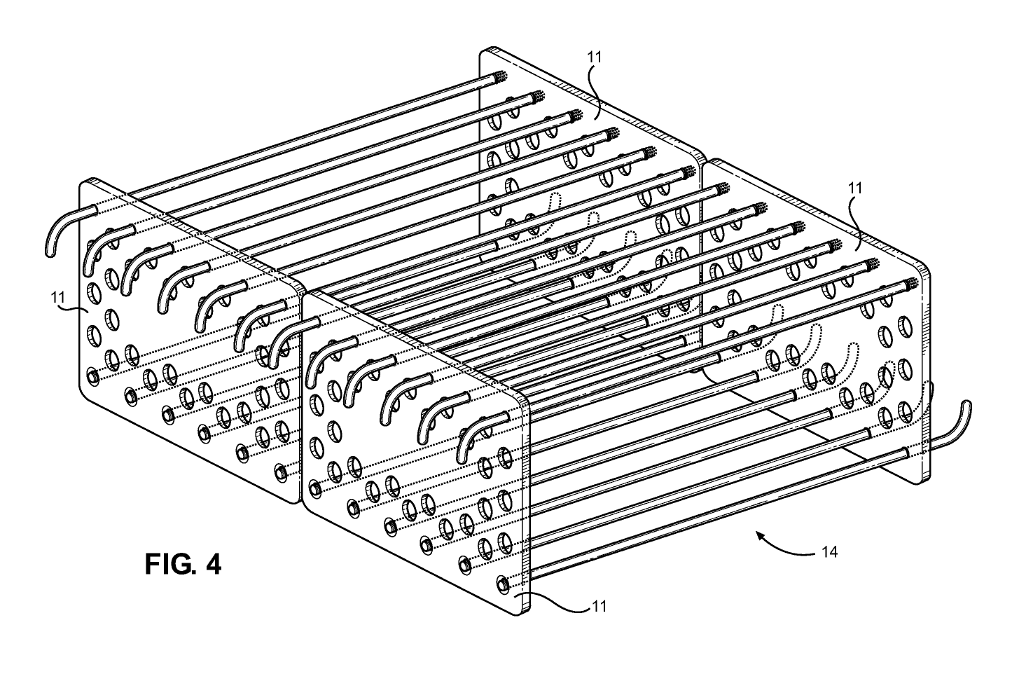

Referring now to FIG. 4, there is shown a perspective view of multiple grills of the present invention aligned together. In the preferred embodiment of the present invention, the side edges of the vertical supports 11 are flat, allowing multiple collapsible grills to be aligned together to form even larger cooking and heat source-supporting surfaces. In an alternative embodiment of the present invention, the edges of the vertical supports 11 may have cutouts that engage with complimentary tabs (not shown) on another vertical support 11 to hold the pair of collapsible grills securely together.

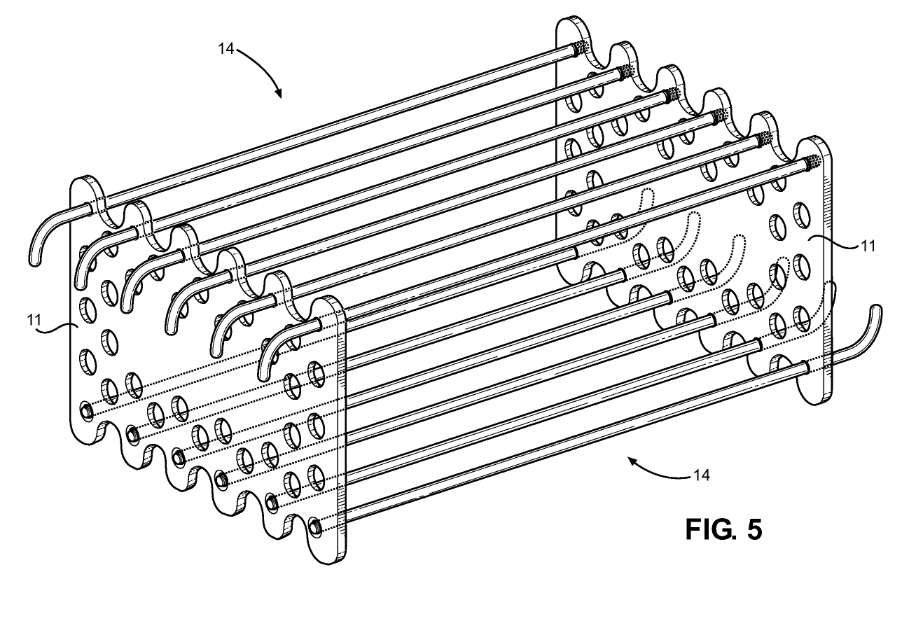

Referring now to FIG. 5, there is shown a perspective view of an alternative embodiment of the present invention having scalloped edges. The scalloped edges are designed to support shish-kabobs or a rotisseries thereacross. The scalloped edges on the non-cooking surface side of the present invention do not otherwise interfere with the operation of the present invention because they still provide an edge upon which the vertical supports 11 can rest.

Overall, the present grill provides a unique device for grilling food while hiking or camping that assembles and dissembles extremely easily and without a substantial time investment. The grill is easily stored and transported because it is small in size and breaks into two simple types of parts: two vertical supports and a plurality of grill bars. The grill further provides a broad surface upon which multiple items may be cooked simultaneously, unlike many canister grill models. The grill also provides a mechanism for preventing overheating, ensuring that food is not burned when cooked thereon.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A collapsible grill, comprising:
a first and second vertical support;
said vertical supports having a row of tapped apertures along one edge and a row of pass-through apertures along an opposing edge, wherein said row of tapped apertures of said first vertical support are aligned with said row of pass-through apertures of said second vertical support and said row of pass-through apertures of said first vertical support are aligned with said row of tapped apertures of said second vertical support;
a plurality of grill bars having a threaded end, an elongated portion, and a blocker;
said threaded end adapted to engage with said tapped apertures;
said grill bars slidably insertable through said pass-through apertures;
said blocker adapted to prevent said grill bars from sliding completely through said pass-through apertures.

2) The collapsible grill of claim 1, further comprising a plurality of heat dispersion apertures disposed on said vertical supports.

3) The collapsible grill of claim 1, wherein said blocker comprises a curved end.

4) The collapsible grill of claim 1, wherein said vertical support edges are scalloped.

5) The collapsible grill of claim 1, wherein said grill bars are composed of cast iron.

6) The collapsible grill of claim 1, wherein said grill bars are composed of stainless steel.

7) The collapsible grill of claim 1, wherein said grill bars are coated with a non-stick material.
